(19) United States
(12) Patent Application Publication
(10) Pub. No.: US 2006/0007389 A1
(43) Pub. Date: Jan. 12, 2006

(54) Spectacle family having differently curved frames and interchangeable stems

(76) Inventors: Renata Fusi, Milano (IT); Silvana Mollica, Milano (IT); Paolo Zanotto, Milano (IT)

Correspondence Address: YOUNG & THOMPSON, 745 SOUTH 23RD STREET, 2ND FLOOR, ARLINGTON, VA, 22202, US

(21) Appl. No.: 10/275,381

(22) PCT Filed: Apr. 5, 2001
(86) PCT No.: PCT/IB01/00573

§ 371 Date: Jun. 6, 2003

(30) Foreign Application Priority Data
May 5, 2000 (IT) M 12000U000274

(51) Int. Cl. G02C 5/14

(52) U.S. Cl. 351/116

(57) ABSTRACT

A spectacle family having frames with different curvatures and extensions provided with engaging elements for removable mounting of stems, the engaging elements having at least one locating surface between each removable stem and the frame, fixed to the frame and having an attitude and a first distance which are constant with respect to an axis of symmetry of the spectacles.

The present model relates to a series or family of spectacles with frames having different curvatures. In particular, it relates to a family of spectacles in which the different frames may be assembled with the same stems without the wearability being affected in any way.

As is known, many types of spectacles with the most varied shapes, forms, colours and uses exist on the market, said spectacles being carefully designed and adjusted taking into account not only aesthetic, but also ergonomic requirements, namely the compliance with precise dimensional ratios in order to ensure comfortable use thereof.

In particular, the most important parameters which must be taken into account include the extension and curvature of the frame (which we shall define below, using an unconventional classification, of “base N”, where “N” is an integer which is higher the more pronounced the curvature).

These parameters determine, among other things, the length and the shape of the stems. In fact, as can be understood, the greater the extension and the curvature of the frame, the more the lateral ends, on which the stems are normally hinged, will be set back with respect to the bridge and therefore the shorter shall be the stems. Consequently, even though the frames may belong, for example, to a same ornamental family, respective proprietary stems must be designed and manufactured for each specific extension and/or curvature of each frame.

This is, however, disadvantageous both from a production point of view and from the point of view of management of warehouse supplies.

For some time now, spectacles with stems which may be removably fixed to the frame by means of fairly standardised interlocking hinging systems exist on the market, resulting in more flexible management of the warehouse stocks and in a certain degree of interchangeability between the various parts. However, this approach, per se, is not yet entirely satisfactory and only partially solves the problems of the known art.

The object of the present invention is therefore to provide a spectacles family which completely overcomes the drawbacks mentioned above, i.e. envisages a series of improved frames which, although having a different curvature and extension, use identical stems.

This object is achieved by means of a family of spectacles, the essential features of which are described in the accompanying claims.

Further details and characteristic features of the frames and the stems according to the invention will appear clearly from the detailed description which follows, considered in conjunction with the accompanying drawings, in which:

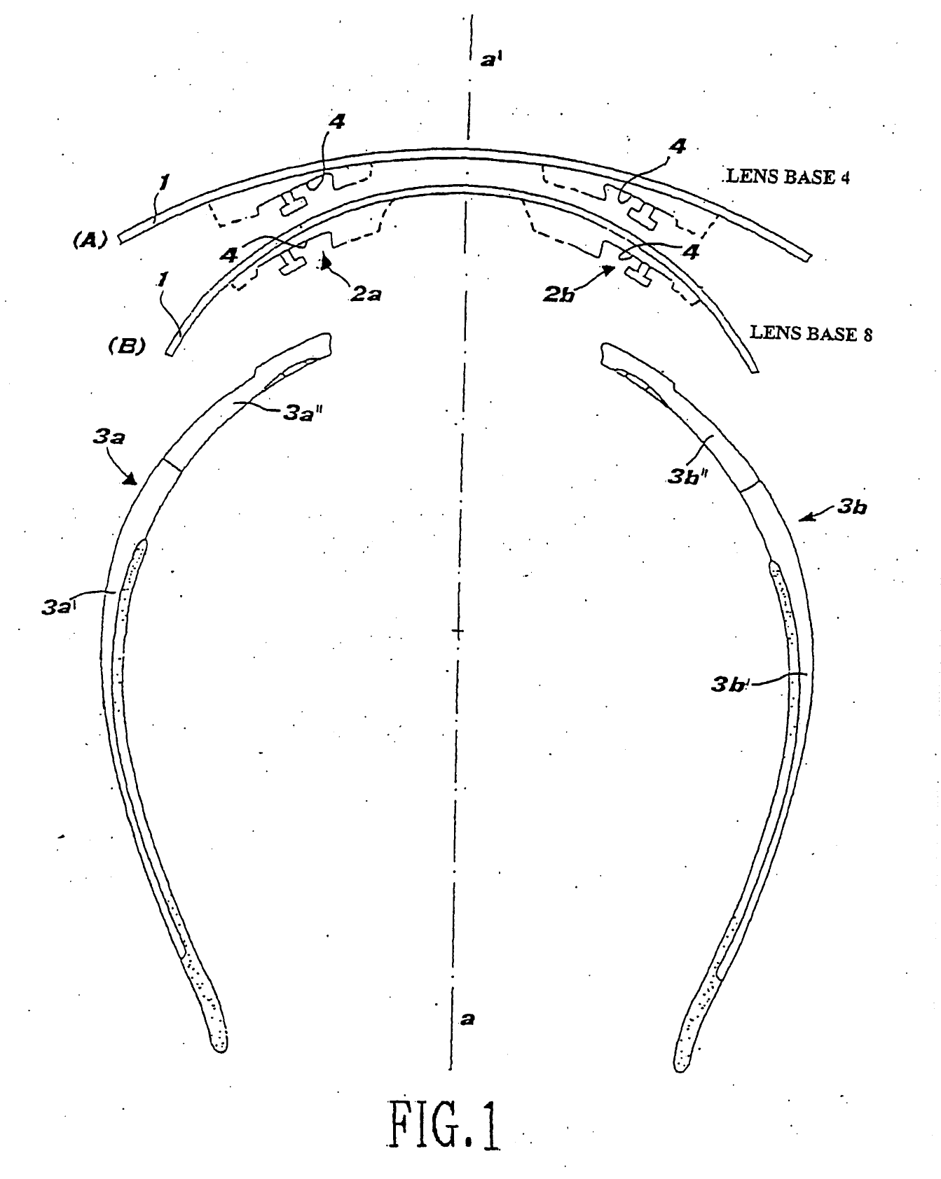

FIG. 1 is a schematic plan view which shows two stems arranged in the vicinity of two frames with different curvature;

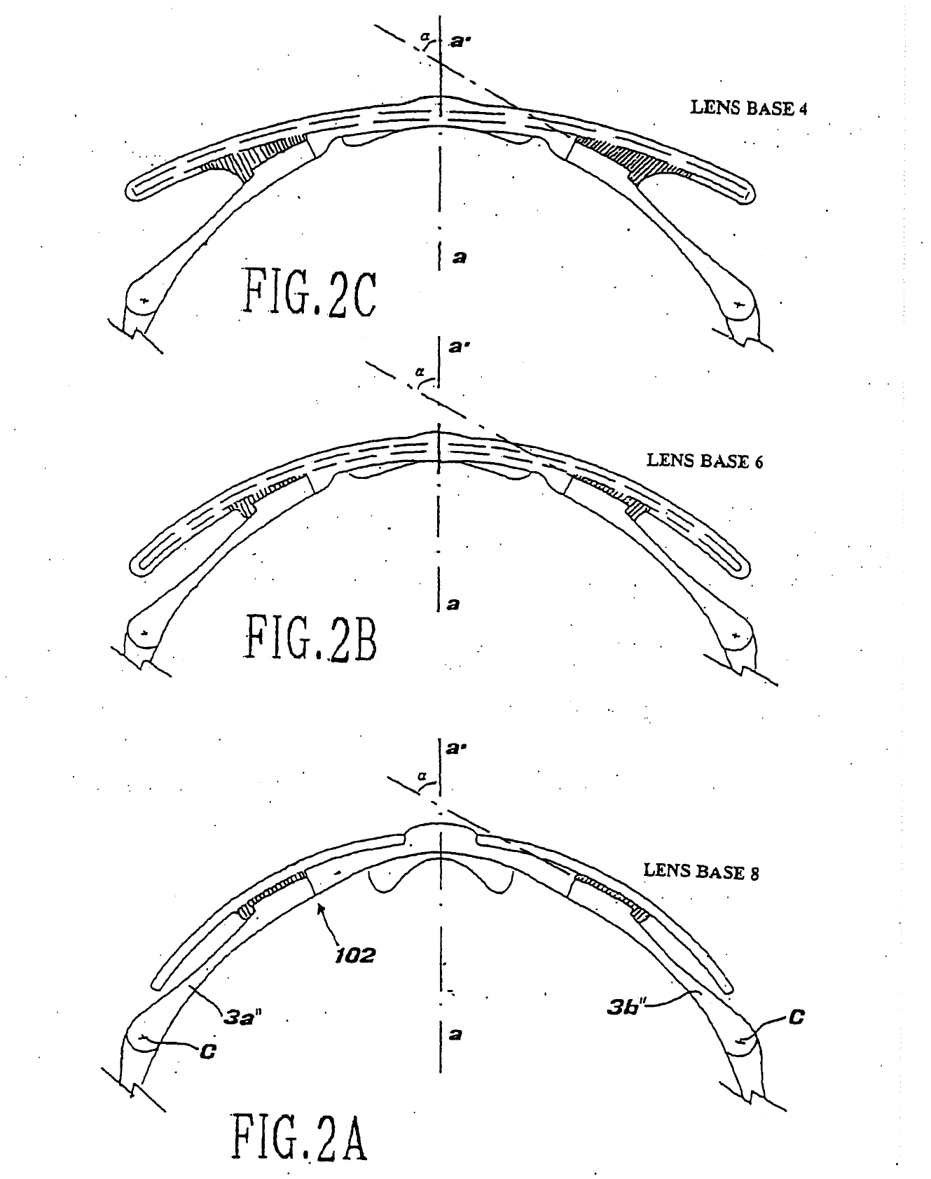

FIGS. 2A-2C are partial schematic plan views of three spectacles belonging to a same family according to the invention; and

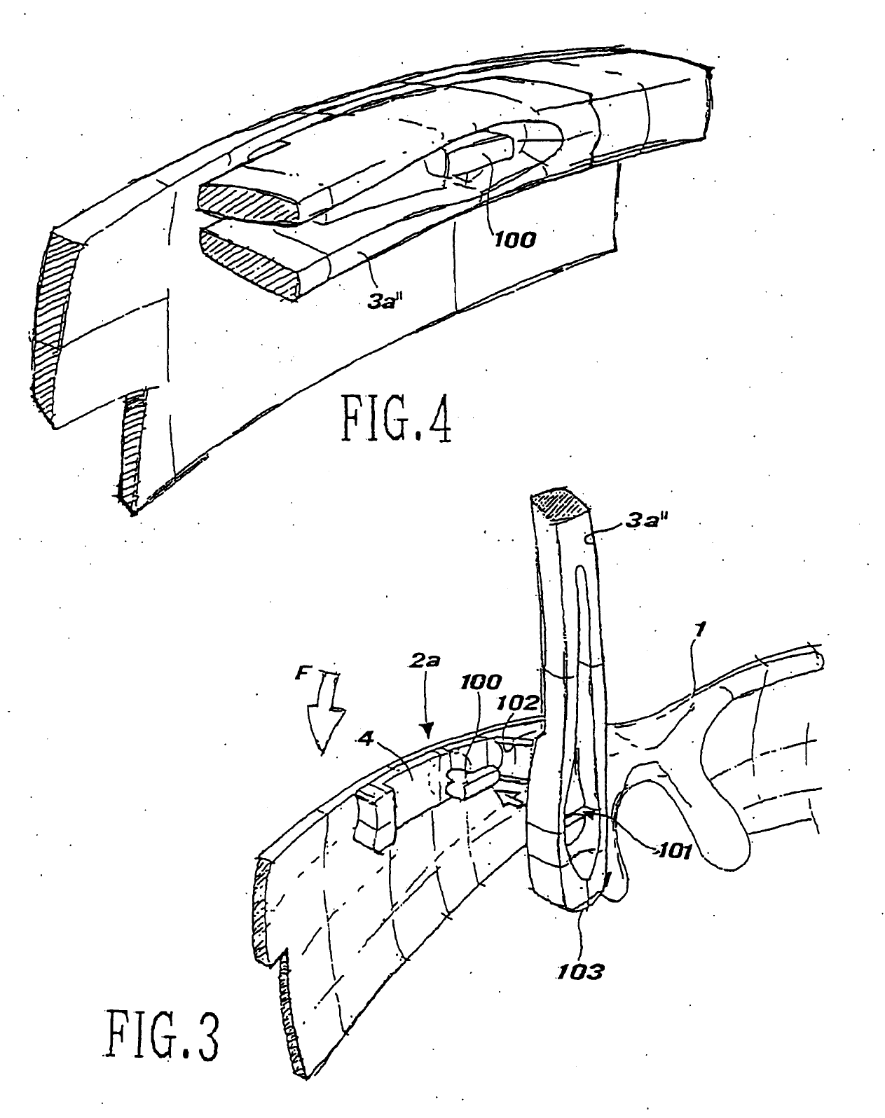

FIGS. 3 and 4 are partial perspective views, on a larger scale, which show a detail of an example of a system for mounting the stem on the frame, in the engaging position and in the locked position, respectively.

As can be noted from FIG. 1 and FIGS. 2A-2C, a same family of spectacles (for example with the same aesthetic appearance) has frames 1 which have different curvatures, for example are fitted with “base 4” lens (example A) or “base 8” lens (example B). It can be understood that, if the stems were hingeably mounted in a conventional manner on the two ends of the frames, they would have to have different lengths and forms for each specific frame base.

According to the present invention, each frame in the family of spectacles is provided with a rapid-engagement system 2a and 2b for the stems 3a and 3b. The rapid-engagement system 2a and 2b may use any technical principle already known per se, but in an original manner has a locating surface or plane 4 which maintains a position and attitude (angle α) with respect to an axis of symmetry a-a′ of the spectacles, which are substantially constant for the entire family to which said spectacles belong.

Consequently, the body of the rapid-engagement elements 2a and 2b which carries the locating surface 4 has a thickness which is variable from one frame to another within the same family of spectacles, precisely so as to allow the two abovementioned parameters to be kept constant.

In this connection, it is understood that the locating surface for the frame and the stems is not necessarily the plane 4 indicated in the figures, but any coupling surface having the abovementioned characteristics. For example, another locating surface according to the invention is that indicated by the number 102.

Advantageously, the distance of the engaging elements 2a and 2b from the axis of symmetry of the spectacles (or, in an equivalent manner, of the coupling zone between the stems and frame) is less than 42 mm and preferably less than 38 mm: this allows the variation in thickness of the body of these elements to be kept within acceptable limits, also for a family of spectacles having curvatures varying from “base 4” to higher bases.

The body of the engaging elements 2a and 2b may be moulded as one piece with the frame 1, but may also be made separately so as to be later assembled by means of fitting with the frame 1 (using glue if necessary) performed by the user. According to this latter embodiment, the package containing the spectacles, when purchased, contains a plurality of carrying bodies with locating surfaces 4, of varying thickness, which the user will choose and fit (arranging them between the frame and the stems) depending on his/her preferences or the form of his/her head.

According to the invention, preferably each stem 3a, 3b is formed by a main portion 3a′ and 3b′ with which a connecting portion 3a″ and 3b″ is hinged.

The connecting portions have a dual function: on the one hand, they are designed to ensure firm fastening of the stems to the frame engaging elements and, on the other hand, they transfer, laterally towards the outside of the frame (as can be clearly understood from FIGS. 2A-2C), the hinging point C of the stems, which otherwise could interfere with the user's face.

Since the connecting portions 3a″ and 3b″ may be easily engaged with and disassembled from the frame, the latter may be moulded without particular technical problems. Otherwise, in the case of frames with a more pronounced curvature, such as that with a “base 8” curvature shown in FIG. 2A, an undercut would be formed between the connecting portion and the frame itself, resulting in considerable complications during the removal of parts from the mould.

Finally, FIGS. 3 and 4 show an example of an engaging element consisting of a T-shaped pin 100 which can be inserted into a rectangular opening 101 formed in the end of the connecting portion 3a″ of the stem 3a. In the position shown in FIG. 3, the stem may be freely engaged with the pin 100 until it abuts against the locating surface 4 of the frame 1. By means of anti-clockwise rotation through 90° (in the direction of the arrow F in the drawing), the opening 101 is arranged in a position which prevents disengagement from the pin 100: in the position shown in FIG. 4, therefore, the stem is perfectly engaged and locked with the frame. Suitable mutually engaging surfaces 102 and 103, respectively belonging to the engaging element and to the connecting portion of the stem, are provided in order to prevent accidental rotation of the stem from its locked position in FIG. 4.

With the family of spectacles according to the invention the objects indicated in the introductory paragraphs have therefore been fully achieved. In fact, the frames of the said family, although differing from each other in terms of curvature and extension, may use the same stems: in this way the desired savings in terms of production and storage are achieved.

Furthermore, it is possible to provide a product which may be customized by the purchaser in accordance with his/her requirements. Finally, the convenient interchangeability of the stems, which form the most inexpensive part of the spectacles, allows easy and advantageous replacement in the event of defects or accidental breakage.

It is understood, however, that the present invention has been described in detail with reference to certain preferred non-limiting embodiments thereof; therefore it must be understood that the scope of protection offered embraces any other variant which employs the same teachings.

For example, the material used for manufacturing the spectacle family may be either metal or plastic, depending on the aesthetic requirements. Finally, many other engaging systems may be used, such as a pin emerging from the surface 102 and engaging in bayonet fashion longitudinally inside the stem.

1. Spectacle family having frames with different curvatures and extensions provided with engaging elements for removable mounting of stems, characterized in that said engaging elements have at least one locating surface between each removable stem and the frame, fixed to said frame and having an attitude and a first distance which are substantially constant with respect to an axis of symmetry of the spectacle.

2. Spectacle family according to claim 1, in which said engaging elements comprise a carrying body for said locating surface which has variable dimensions depending on the extension and curvature of said frames.

3. Spectacle family according to claim 2, in which said locating surface is substantially flat and said carrying bodies are generally in the form of wedge of variable thickness.

4. Spectacles family according to any one of the preceding claims, in which said stems comprise a main portion with which a connecting portion is hinged, the latter being designed to engage with said engaging element of the frame.

5. Spectacles family according to claim 4, in which said connecting portion is also apt to transfer the hinging point of the stem to a second distance from the axis of symmetry of the spectacle so as not to cause interference between said stem and the user's face.

6. Spectacle family according to any one of the preceding claims, in which said first distance from the axis of symmetry of the spectacle is less than 42 mm and preferably less than 38 mm.

7. Spectacle family according to any one of claims 2 to 6, in which said carrying body is envisaged as being a separate part which can be fixed by the user to said frame.
